(19) United States
(12) Patent Application Publication
(10) Pub. No.: US 2015/0212047 A1
(43) Pub. Date: Jul. 30, 2015

(54) Test Method for Sound Wave Detection of Cup Bottom

(71) Applicant: Power Source and Associates Corp., Taipei (TW)

(72) Inventors: Tzu-Chi LIN, Taipei (TW); Hsien-Jen LIN, Taipei (TW)

(73) Assignee: Power Source and Associates Corp., Taipei (TW)

(21) Appl. No.: 14/219,170

(22) Filed: Mar. 19, 2014

(30) Foreign Application Priority Data
Jan. 27, 2014 (TW) 103102986

(51) Int. Cl. G01N 29/04

(52) U.S. Cl. CPC G01N 29/04; G01N 2291/0237

(57) ABSTRACT

Provided is a test method for sound wave detection of a cup bottom, including: providing a sound-collecting dish, producing a good voiceprint, testing a cup under test, and performing compliance identification. Further provided is a test module which includes the sound-collecting dish, a processing unit and a memory unit. With the test method, it is practicable to perform an effective test on a cup bottom of a cup under test quickly by means of voiceprint testing to reject bad products and collect good cups, thereby ensuring the high quality of the cups thus manufactured.

### BACKGROUND OF THE INVENTION

1. Technical Field

The present invention relates to test methods for cup bottoms, and more particularly, to a test method for sound wave detection of a cup bottom by an acoustic pattern test module.

2. Description of Related Art

Paper cups, together with disposable cups, are heavily used and have a wide variety of applications in modern societies with busy lifestyles and top priority given to efficiency. Paper cups, from ones made of paper by a simple manufacturing process to delicate ones for holding hot soups, coffee, or noodle, are in wide use at any time and any place.

However, there are good as well as bad cups in terms of quality. When using cups to hold hot drinks or hot soups, users often get burnt because the bottoms of the cups are defectively manufactured. Defectively manufactured bottoms of cups will bring inconvenience to users, even in case of a spill of cold drinks instead of hot drinks contained in the cups.

Accordingly, it is important for cup manufacturers to provide an innovative test method for selecting and rejecting cups with bad cup bottoms in a simple and precise manner before delivery of cups, so as to effectively avoid the inconvenience and even injuries otherwise caused to users by the bad cup bottoms.

### SUMMARY OF THE INVENTION

The present invention relates to a test method for sound wave detection of a cup bottom. With the test method, it is practicable to perform an effective test on a cup bottom of a cup under test quickly by means of voiceprint testing, thereby ensuring the high quality of the cups thus manufactured.

The present invention provides a test method for sound wave detection of a cup bottom, comprising the steps of: providing a sound-collecting dish being dish-shaped and having therein a acoustic pattern test module for emitting and receiving sound waves; producing a good voiceprint, by covering at least a good cup from above, in sequence, with the sound-collecting dish, emitting a standard sound wave from the acoustic pattern test module into each of the at least a good cup, and receiving reflected sound waves of each of the at least a good cup by the acoustic pattern test module, so as to produce a good voiceprint; testing a cup under test, by covering at least a cup under test from above, in sequence, with the sound-collecting dish, emitting the standard sound wave from the acoustic pattern test module into each of the at least a cup under test, receiving the reflected sound waves of each of the at least a cup under test by the acoustic pattern test module, so as to produce a test voiceprint; and performing compliance identification, by comparing each said test voiceprint and the good voiceprint to identify whether each of the at least a cup under test is a good cup.

Implementation of the present invention at least involves the following inventive steps:

1. ensure that cup bottoms can be manufactured and installed quickly, easily, and cheaply;

2. ensure that every cup delivered will have a good cup bottom; and

3. ensure that every cup delivered will be safe to use and will not cause inconvenience or injuries to users because of its cup bottom gets damaged.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE SEVERAL VIEWS OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a schematic view of the process flow of a test method for sound wave detection of a cup bottom according to an embodiment of the present invention;

FIG. 2A is a schematic perspective view of a test device for sound wave detection of a cup bottom according to the embodiment of the present invention;

FIG. 2B is another schematic perspective view of the test device for sound wave detection of a cup bottom according to the embodiment of the present invention;

FIG. 3 is yet another schematic perspective view of the test device for sound wave detection of a cup bottom according to the embodiment of the present invention; and

FIG. 4 is a block diagram of a test module for sound wave detection of a cup bottom according to the embodiment of the present invention.

### DETAILED DESCRIPTION OF THE EMBODIMENT OF THE INVENTION

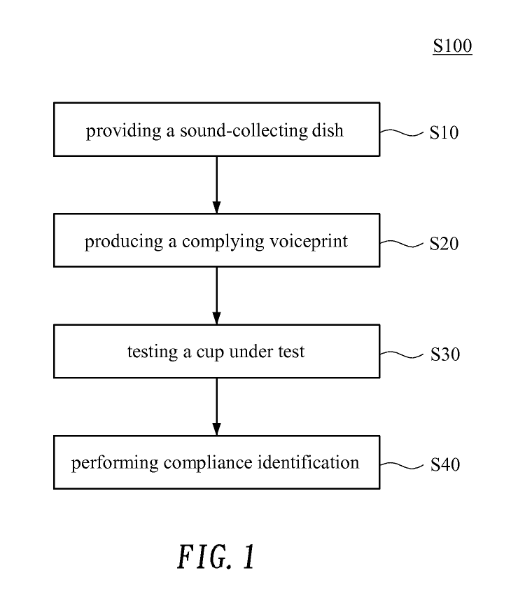

Referring to FIG. 1, in an embodiment of the present invention, a test method S100 for sound wave detection of a cup bottom comprises the steps of: providing a sound-collecting dish (step S10); producing a good voiceprint (step S20); testing a cup under test (step S30); and performing compliance identification (step S40).

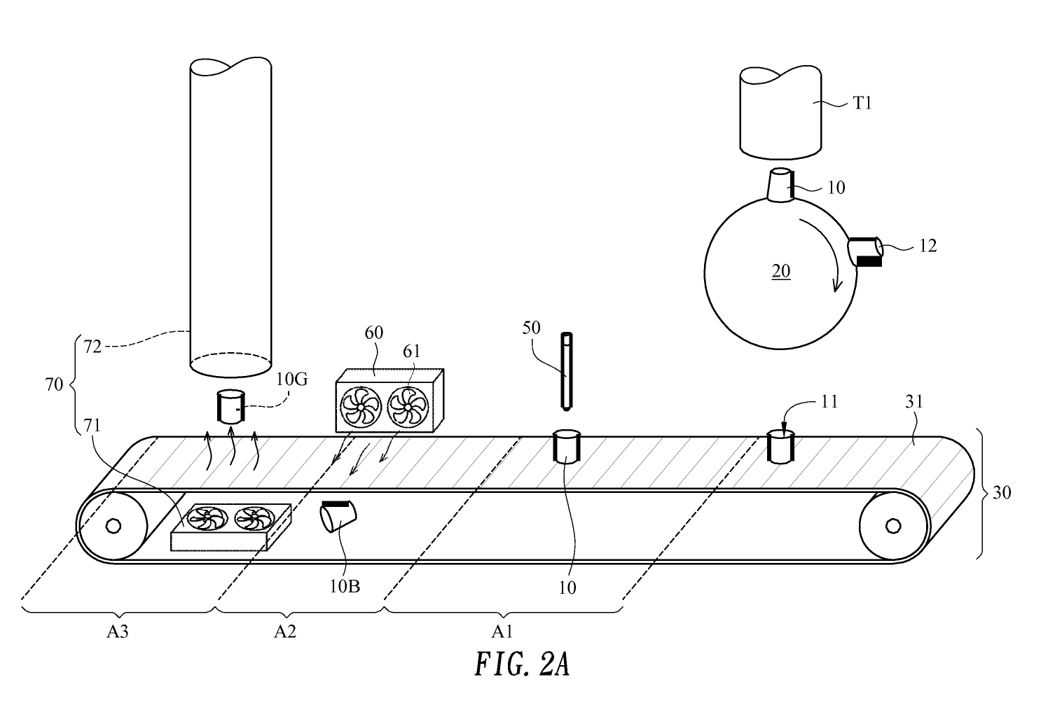

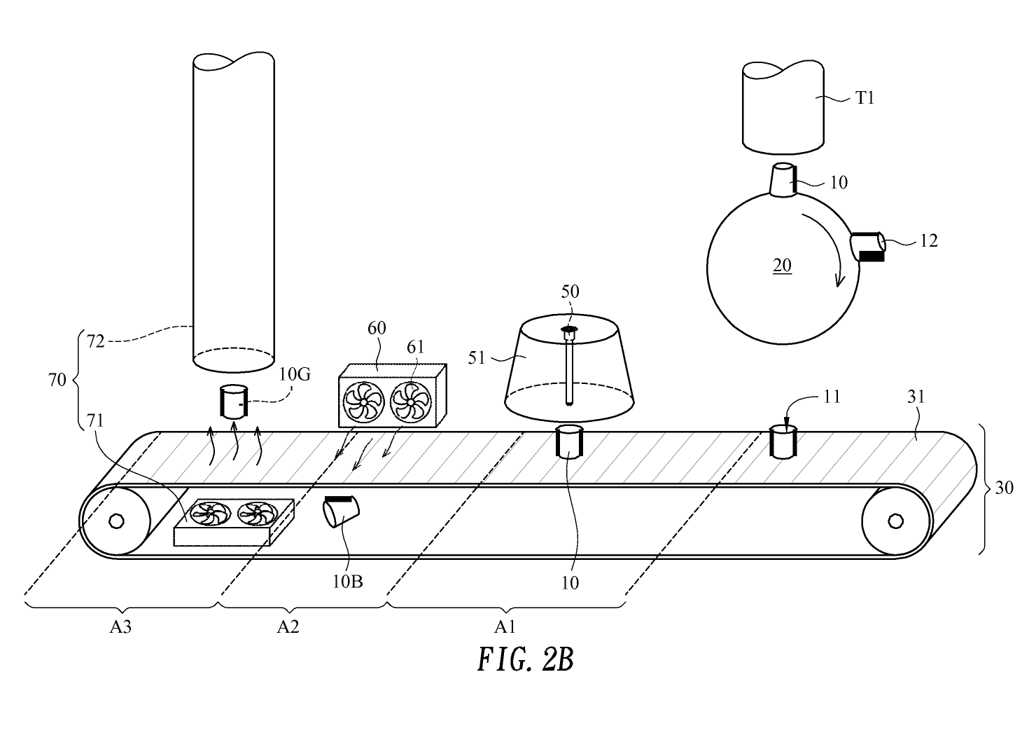

Referring to FIG. 2A and FIG. 2B, in an embodiment of the present invention, a test system 100 for carrying out the test method S100 for sound wave detection of a cup bottom comprises a feeding module T1, a vacuum ball 20, a conveying module 30, a acoustic pattern test module 50, a sound-collecting dish 51, a rejection module 60 and a collection module 70.

Referring to FIG. 1 through FIG. 2B, in the step of providing a sound-collecting dish (step S10), the sound-collecting dish 51 is dish-shaped and covers a cup mouth 11 of a cup under test 10 from above. The sound-collecting dish 51 has therein the acoustic pattern test module 50 for emitting sound waves toward a cup bottom 12 and receiving sound waves therefrom.

Referring to FIG. 1 through FIG. 2B, producing a good voiceprint (step S20) involves covering at least a good cup 10G from above, in sequence, with the sound-collecting dish 51, emitting a standard sound wave from the acoustic pattern test module 50 to the cup bottom 12 of each good cup 10G, and receiving the reflected sound waves of the cup bottom 12 of each good cup 10G by the acoustic pattern test module 50, so as to produce a good voiceprint.

In an embodiment of the present invention, the good voiceprint for use as a comparison-related reference is produced by detecting the cup bottoms 12 of multiple (say, 10) good cups 10G with the acoustic pattern test module 50, creating a good voiceprint from data detected, and storing the good voiceprint for use as a comparison-related reference.

Furthermore, a bad voiceprint for use as a comparison-related reference is produced by detecting the cup bottoms 12 of multiple (say, 10) bad cups 10B with the acoustic pattern test module 50, creating a bad voiceprint from data detected, and storing the bad voiceprint for use as a comparison-related reference.

Referring to FIG. 1 through FIG. 2B, testing a cup under test (step S30) involves covering at least a cup under test 10 from above, in sequence, with the sound-collecting dish 51, emitting the standard sound wave from the acoustic pattern test module 50 to the cup bottom 12 of each of the at least a cup under test 10, and receiving the reflected sound waves of the cup bottom 12 of each of the at least a cup under test 10 by the acoustic pattern test module 50, so as to produce a test voiceprint.

Referring to FIG. 1 through FIG. 2B, performing compliance identification (step S40) involves comparing each said test voiceprint and the good voiceprint to identify whether each said cup under test 10 is a good cup 10G.

In an embodiment of the present invention, performing compliance identification involves determining by the acoustic pattern test module 50 that the cup under test 10 is a good cup 10G when the difference between the test voiceprint of the cup bottom 12 of the cup under test 10 and the good voiceprint is not larger than ±3%.

Alternatively, the acoustic pattern test module 50 determines that the cup under test 10 is a bad cup 10B when the difference between the test voiceprint and the bad voiceprint is not larger than ±3%.

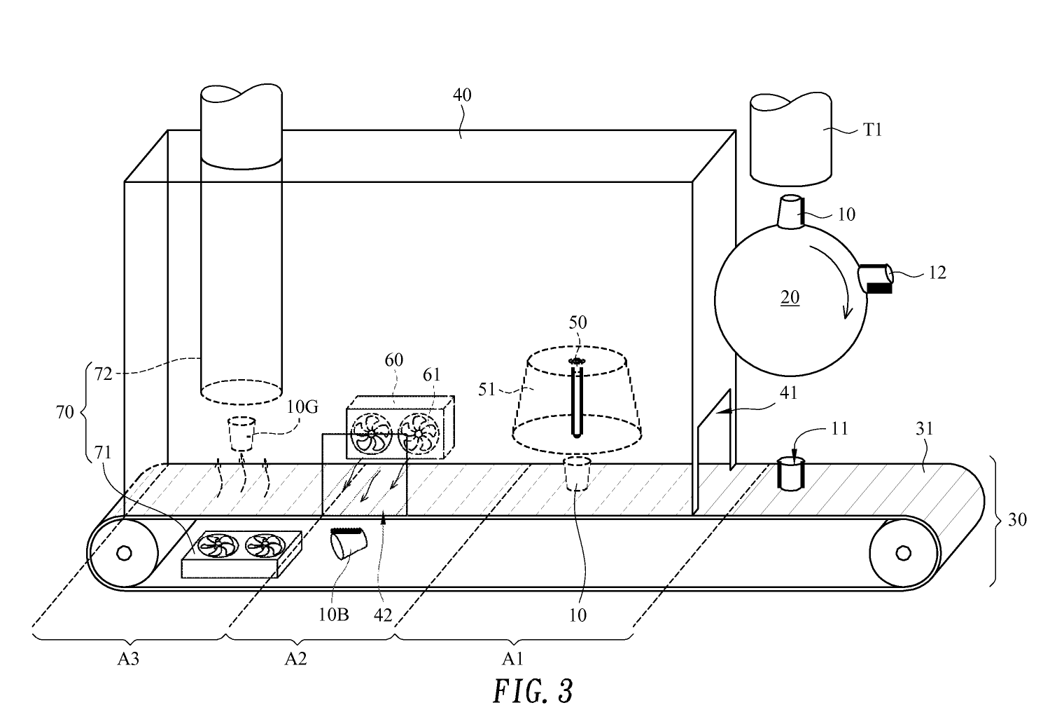

Referring to FIG. 3, the test system 100 for sound wave detection of a cup bottom further has a box 40. The box 40 hides a portion of the conveying module 30 and has a feed port 41 and a rejection opening 42. The test area A1, rejection area A2, and collection area A3 of the conveying module 30 are hidden by the box 40. A conveyor belt 31 of the conveying module 30 conveys the cup under test 10 from the feed port 41 into the box 40. The bad cup 10B is controllably rejected and removed from the box 40 through the rejection opening 42 by means of the rejection module 60.

Referring to FIG. 3, the box 40 fends off interference from external noise or air current to ensure accuracy in the testing of the cup bottoms 12 of the cup under tests 10 by the test system 100 for sound wave detection of a cup bottom.

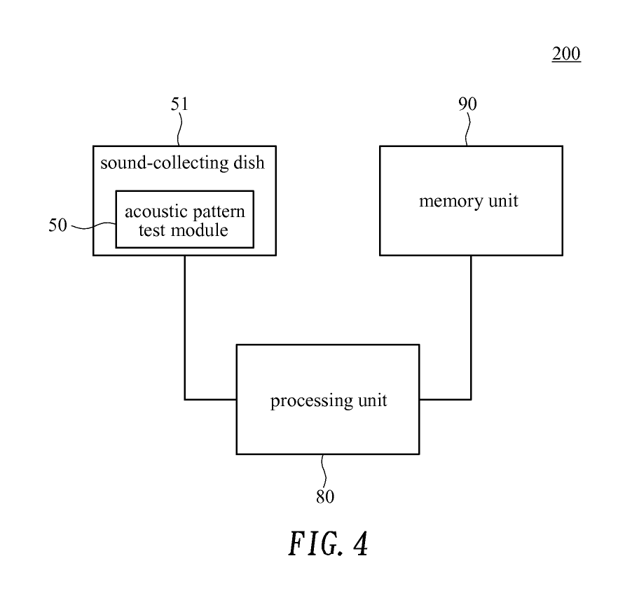

Referring to FIG. 4, in an embodiment of the present invention, a test module 200 for sound wave detection of a cup bottom comprises a sound-collecting dish 51, a processing unit 80, and a memory unit 90.

Referring to FIG. 4, the sound-collecting dish 51 is dish-shaped and has therein the acoustic pattern test module 50. The technical features of the acoustic pattern test module 50 are described before and thus are not described again hereunder for the sake of brevity.

Referring to FIG. 4, the processing unit 80 controls the operation of the sound-collecting dish 51 and reads signals from the acoustic pattern test module 50 to carry out the step of producing a good voiceprint, the step of testing a cup under test and the step of performing compliance identification. The technical features of the step of producing a good voiceprint, the step of testing a cup under test, and the step of performing compliance identification are identical to those of the aforesaid step of producing a good voiceprint (step S20), step of testing a cup under test (step S30), and step of performing compliance identification (step S40) of the test method S100 for sound wave detection of a cup bottom and thus are not described again hereunder for the sake of brevity.

Referring to FIG. 4, the memory unit 90 stores the good voiceprint and at least a test voiceprint according to a command from the processing unit 80. The good voiceprint and the at least a test voiceprint stored in the memory unit 90 are accessible by the command from the processing unit 80 to enable the processing unit 80 to perform compliance identification (step S40) on the cup under test 10 and thus determine whether the cup under test 10 is a good cup 10G.

As indicated by the above embodiments, the test method S100 for sound wave detection of a cup bottom entails detecting the cup bottom 12 to obtain a test voiceprint with the acoustic pattern test module 50, comparing the test voiceprint and the good voiceprint or bad voiceprint, determining whether the cup under test 10 is a good cup 10G or bad cup 10B, rejecting, with the rejection module 60, the bad cup 10B determined by the acoustic pattern test module 50, conveying the good cup 10G to the collection area A3 with the conveyor belt 31, and collecting the good cups 10G with the collection module 70, thereby ensuring the high quality of the paper cups thus manufactured.

The embodiments described above are intended only to demonstrate the technical concept and features of the present invention so as to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. A test method for sound wave detection of a cup bottom, comprising the steps of:
providing a sound-collecting dish being dish-shaped and having therein a acoustic pattern test module for emitting and receiving sound waves;
producing a good voiceprint, by covering at least a good cup from above, in sequence, with the sound-collecting dish, emitting a standard sound wave from the acoustic pattern test module into each of the at least a good cup, and receiving reflected sound waves of each of the at least a good cup by the acoustic pattern test module, so as to produce a good voiceprint;
testing a cup under test, by covering at least a cup under test from above, in sequence, with the sound-collecting dish, emitting the standard sound wave from the acoustic pattern test module into each of the at least a cup under test, receiving the reflected sound waves of each of the at least a cup under test by the acoustic pattern test module, so as to produce a test voiceprint; and
performing compliance identification, by comparing each said test voiceprint and the good voiceprint to identify whether each of the at least a cup under test is a good cup.

2. The test method of claim 1, wherein the acoustic pattern test module will determine that the cup under test is a good cup, provided that the difference between the test voiceprint and the good voiceprint is not larger than ±3%.

3. The test method of claim 1, wherein the good voiceprint is produced by performing the good voiceprint producing step on 10 said good cups.

4. The test method of claim 1, wherein the standard sound wave is of 0 Hz to 1500 Hz.

5. The test method of claim 1, wherein the standard sound wave is of 0 Hz to 5000 Hz.
